(19) United States
(12) Patent Application Publication
(10) Pub. No.: US 2018/0325161 A1
(43) Pub. Date: Nov. 15, 2018

(54) FOAMING APPARATUS AND METHOD OF USE

(71) Applicant: MANY RIVERS DESIGN LIMITED, Waimauku (NZ)

(72) Inventor: Peter Stuart JOHNSON, Waimauku (NZ)

(21) Appl. No.: 15/770,568

(22) PCT Filed: Oct. 24, 2016
(86) PCT No.: PCT/NZ2016/050173

§ 371 Date: Apr. 24, 2018

(30) Foreign Application Priority Data
Oct. 24, 2015 (NZ) 711162

(51) Int. Cl. A23P 30/40; A23L 15/00; B65D 30/22

(52) U.S. Cl. CPC A23P 30/40; A47J 43/10; B65D 31/12; A23L 15/00

(57) ABSTRACT

The present invention relates to a foaming apparatus wherein the apparatus includes an enclosure with a first and second cavity located therein wherein the enclosure includes at least one zone of constriction defined by internal surface(s) of the enclosure located between the first cavity and the second cavity in the enclosure, wherein the at least one zone of constriction allows the only transfer of a material between the first cavity and second cavity. The present invention also relates to a method of using a foaming apparatus to foam a material such as an egg white based liquid.

### BACKGROUND OF THE INVENTION

### 1. Technical Field

The present invention relates to a foaming apparatus and method of use, and particularly though not solely for foaming egg white based compositions.

### 2. Background Art

Egg white is a commonly utilized food material because of it is widely available and inexpensive to obtain, and has a good shelf life at room temperature in the unshelled egg form. Egg white can also be prepared and sold in a ready to purchase in a liquid form (EWL), conveniently separated from the egg yolk and shells. Egg white is also conveniently provided as a powder (EWP).

Egg whites have particularly beneficial nutritional qualities, being high in readily absorbable protein and essential amino acid content, and low in cholesterol, fats and sugar. For this reason, egg white based products have become a very popular nutritional supplement for sports athletes, amongst other nutritional uses. Yet, a downside to consuming egg whites is their rather displeasing association with raw eggs, especially in the liquid format. To avoid the thought of eating raw egg whites, people often resort to mixing the egg whites in a blender with other ingredients to mask the mouth feel and look of the product when drunk in its raw liquid form.

One of the attributes of egg whites is the ability to be foamed, which then has a pleasing mouth feel, texture and look that can be mentally disassociated with raw liquid egg whites. In this sense, egg white foams could represent a “dairy free based milkshake alternative” which has good sensory perception compared to liquid egg whites. Yet because of the difficulty in foaming egg whites as discussed below, foamed egg whites have conventionally only been used for cooking purposes, such as making pavlovas.

There are three main methods to develop foamed egg whites; namely whipping, gas sparging and shaking.

Whipping egg white liquid is the most commonly used method, but is generally restricted to a kitchen setting. It relies on imparting mechanical forces on the egg white to produce foams that typically can last approximately one hour before the foam volume starts to subside. This can be enough time to then cook the foamed food product if required, allowing the foam structure to be maintained long term (e.g. in a Pavlova). The mechanical forces can be provided by hand using a whisk, or for instance by using an electric mix beater, blender or so forth.

Although the whipping method is widely used and provides an acceptably stable foam, it can take significant time to produce the foam and therefore does not provide a convenient, ready to use egg white foam. Results can also be inconsistent depending on the user, force applied and so forth. It can also be completely impractical for foaming egg whites outside of a kitchen environment.

Gas sparging is a much less commonly used technique to produce foamed egg white. Essentially, the method involves injecting the egg white solution with a gas such as nitrogen (N2) under pressure (for instance in a sealed canister), and then the solution is released quickly through a nozzle in the canister, at which point the gas bubbles quickly expand to produce the egg white foam.

This method provides an improved level of convenience (i.e. it is essentially immediate) and a high degree of reproducibility compared to the whipping method. Yet, a disadvantage is that it requires a pressurized canister. From a manufacturing perspective, producing an egg white foaming product in a sealed pressurized canister can add manufacturing costs, and is likely to make production, storage and distribution problematic.

Although egg white foams could be produced quickly “on the go” by the end user using gas sparging, it is unlikely a user (for instance, an athlete) will want to inject foamed egg white from a canister directly into their mouth. Also it would be inconvenient to have to transfer the foamed egg white to a separate container before then consuming the “milkshake” style foam.

The third option is shaking egg whites in a sealed canister, yet this method is not used often in the kitchen setting because of the poor performance compared to whipping. It would also require about 10-15 minutes of shaking, and still there are likely to be inconsistencies and/or poor foaming results. It would also be impractical for a user to shake a canister when “on the go” for 10-15 minutes, and is clearly why this method has not been adopted.

JP 3761093 describes a device that relies on a nylon based mesh system that resides inside a sealed soft plastic container. By manually pushing egg white back and forth from one side of the mesh system to the other, allegedly a foam can be produced within about one minute, which can then be removed for subsequent cooking use. However there are significant disadvantages with this device. First, the device relies on an internally applied mesh. This can be problematic because of the need to ensure food-grade compliance, avoidance of reactivity with food, stability over time, requirement to sterilize the mesh, and as a result, likely higher manufacturing costs. Additionally, the material to be foamed may become embedded within the mesh. There is also a potential that the mesh may degrade or break apart, causing potential product failure, and more concerning -potential contamination of the food. Also, although one minute is comparatively better than whipping times (typically 10-20 minutes) and may have commercial applicability in a kitchen setting, one minute is still considered to be unreasonable for users to prepare an egg white foam when “on the go”, for instance after or before an exercise workout.

The inventor set out to develop a solution to some or all of these problems, and in particular to:

provide convenient foaming of egg whites quickly and easily without the need for conventional techniques such as whipping, gas sparging and shaking, those of which are particularly impractical for settings outside of the kitchen;

provide a solution to the problem to allow athletes, and other users to quickly and easily make a foamed egg white “on the go”;

avoid the need to drink raw liquid egg whites which has a displeasing mouth feel, look and association with raw eggs, and instead provide a foamed composition which has pleasing sensory perception characteristics;

avoid the need to mask the liquid egg whites by mixing/blending in a blender which is often what athletes currently do (which is also inconvenient);

avoid problems with manufacturing/costs associated with gas sparging methods or alternative foaming methods; and/or

provide a solution to the problem that easily allows flavorings/additives to be added to the raw egg white liquid, such that the resulting egg white foams can be made into a variety of products.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

It is an object of the present invention to address the foregoing problems or at least to provide the public with a useful choice.

Further aspects and advantages of the present invention will become apparent from the ensuing description that is given by way of example only.

### SUMMARY OF THE INVENTION

The present invention provides for a foaming apparatus wherein the apparatus includes an enclosure with a first and second cavity located therein characterized in the enclosure includes at least one zone of constriction defined by internal surface(s) of the enclosure located between the first cavity and the second cavity in the enclosure, wherein the at least one zone of constriction allows the only transfer of a material to be foamed between the first cavity and second cavity, and wherein the zone of constriction is configured to foam the material as the material is transferred through the zone of constriction in a back and forth fashion between the first cavity and the second cavity.

The present invention also provides for a method of foaming a material in an apparatus as described herein wherein the method is characterized by the steps of applying a force to an external portion on the enclosure to cause material transfer under pressure through the zone of constriction, and foaming the material.

### BRIEF DESCRIPTION OF THE DRAWINGS

Further aspects of the present invention will become apparent from the following description which is given by way of example only and with reference to the accompanying drawings in which:

FIG. 1 is a representation of the apparatus according to a first embodiment (front view);

FIG. 2 is a representation of the apparatus according to a first embodiment (side view);

FIG. 3 is a representation of the apparatus according to a further embodiment (front view);

FIG. 4 is a representation of the apparatus according to a further embodiment (side view); and

FIG. 5 is a representation of the apparatus according to a further embodiment (cross-sectional view cutaway just above the clamp).

### DETAILED DESCRIPTION OF THE INVENTION

The invention provides a new mechanism and apparatus, generally shown at 1 in the Figures, to quickly and easily foam a material such as egg white liquid (EWL) without the need for whipping, gas sparging, or shaking which are the conventional ways of producing egg white foam. The concept relies on high shear and high pressure of the material through the region of constriction, most often in a back-and-forth manner between the two cavities as will be described further. It has been found that the apparatus works surprisingly well to very quickly foam egg whites within about 15 seconds. This is a significant improvement over the device as described in JP 3761093 which teaches someone to use the device for at least one minute to achieve desirable foaming. Further, the region of constriction may be easily manufactured, and advantageously does not require implanting components into the enclosure, such as is required in JP 3761093 (a nylon mesh structure, which does not form a zone of constriction in the enclosed cavity, and/or does not function through high pressure/high shear).

Apparatus

Throughout the specification the term enclosure 2 should be taken as meaning any container, apparatus, bag, canister or so forth that is configured to retain an amount of a foamable material such as an egg white liquid based composition. The enclosure 2 should be understood to optionally have a means to incorporate a material to be foamed, and which may also serve as a means to dispense the foamed material from the apparatus 1 when required. For instance an external outlet with a removable lid may allow this functionality.

Preferably, the apparatus 1, and more specifically the walls of enclosure 2, are made substantially of a pliable material. A soft plastic walled container is considered to be very applicable to the present invention, although other materials may be used.

For example, a pliable material such as soft plastic more easily allows a user to apply a force to difference areas of the apparatus 1 to result in the necessary mechanical forces needed to result in foam being produced in the apparatus 1.

Throughout the specification the term first cavity 8 and second cavity 9 should be taken as meaning areas within the enclosure 2 that are separated from one another by the zone of constriction(s) 6.

Preferably, the internal volume of the first cavity 8 and second cavity 9 are approximately the same.

This may allow increased amount of material to transfer back and forth effectively between the first cavity 8 and second cavity 9 when under appropriate forces applied to the apparatus 1.

Preferably, the first cavity 8 is configured to include an external outlet 3.

In the foaming process, a gas substance may be included in the apparatus 1 prior to foaming a material. Therefore, it is foreseen that in one embodiment, the external outlet 3 can provide the user to manually blow air into the first cavity 8, expanding it, then re-sealing the external outlet 3 prior to carrying out the described method herein to foam the material using the apparatus 1.

The external outlet 3 may also act as a path for the material to initially be introduced during manufacturing, and/or may also act as an outlet to dispense the foam for or prior to consumption.

Alternatively, a gas may already be in the apparatus 1, or may be generated in a gas release system just prior to use. There are well known methods and devices available to generate gas.

In some situations, the material to be foamed may also include an amount of additives such as fruit pieces that may not be sufficiently small to pass through the zone of constriction(s). In such circumstances, the additives may reside in the first cavity 8 such that when the material has been foamed, it may be mixed within the material before being dispensed from the external outlet 3.

Zone of Constriction

Throughout the specification, the term zone of constriction 6 should be taken as meaning a region, path(s), aperture(s), gateway(s), valve(s) or similar within the internal walls of the enclosure 2 that restricts the flow of a material between the first cavity 8 and second cavity 9.

There are a wide number of embodiments in which this invention may be achieved without departing from the scope thereof.

In one aspect, the zone of constriction 6 is configured as at least one channel 7 that forms between opposing portions of the internal walls that are connected along a mid-portion of the enclosure 2 to separate the first cavity 8 from the second cavity 9.

For instance the integral connections on the opposing internal walls along the mid-portion may be provided by heat sealing the apparatus 1 during manufacture.

Preferably, the zone of constriction 6 includes multiple channels 7.

Preliminary trials show that a plurality of channels 7 arranged in a linear fashion along the mid-portion of the enclosure 2 worked well to enable formation of the foamed material, in use. However, it should be appreciated that depending on the material to be foamed, the number and configuration of the channels 7 may vary. For instance, the zone of constriction 6 may be defined simply by having a single channel 7 that may work well for certain materials to be foamed.

It should be appreciated that the particular configuration of the channels 7 that are formed may vary depending on the material to be foamed.

With egg white liquid, the channels 7 may be approximately between 1-10 mm in width, which in preliminary experiments were shown to effectively and quickly foam the egg white liquid. Again, the width of the channels 7 may be adapted to accommodate differences in the material to be foamed. Preliminary experiments showed adequate egg white foam is produced in 10-15 seconds.

This embodiment is particularly commercially viable because there are no internal or external components required, and the zone of constriction 6 is inherently built into the opposing enclosure 2 walls of the apparatus 1. This avoids issues seen in JP 3761093. Furthermore, the resulting rib like structure surprisingly formed adds a significant element of eye appeal to the apparatus 1 especially when the foaming process is initiated (beyond the functional advantages it provides), and may be very useful for marketing purposes, especially for athletes and/or bodybuilders.

In another embodiment, the zone of constriction 6 is provided by a clamp 10 that is applied outside of the apparatus 1 that effectively draws the opposing internal walls of apparatus 1 almost together along a mid-part of the enclosure 2, thus forming the first cavity 8 and second cavity 9 on either side of the clamp 10.

As one example, the clamp 10 may be of a linear configuration that forms a linear zone of constriction 6 inside the enclosure 2. An advantage of a clamp 10 is that it may be configured to be removable and may be used multiple times on different apparatuses 1. The clamp 10 may also function effectively as a holding means such that the user may hold onto the apparatus 1 after foaming the material, to provide easier consumption “on the go”.

Therefore, one will appreciate that in one aspect of the invention, the invention may be a clamp 10 configured to be attached on to an apparatus 1 as described in various embodiments throughout this specification. The clamp 10 configuration would need to be sufficient to form a zone of constriction 6 on an apparatus 1 as described herein.

In another embodiment, the inventor envisions a concept of vending/foaming machine that has a jaw portion that clamps across a mid-section of an apparatus 1 holding a material to be foamed, to form the zone of constriction 6 as herein described. Similarly, the machine may be configured to then provide the mechanical pumping motion to force the material back and forth between a first and second cavity defined within the apparatus 1, following the jaw's clamping. The vending machine may then release the jaw portion, and the apparatus 1 containing the foamed material may then be dispensed to the user for consumption.

Material to be Foamed

Throughout the specification the term material should be taken generally as any substance that is in liquid or semi-liquid form that has functionality and use in a foamed state. In most instances, the invention is most applicable to food or drink, but the invention may be used for a wide number of non-food based materials with commercially relevant uses.

Preferably, the material is an egg white liquid or egg white based composition.

The egg white liquid (EWL) may be reconstituted from egg white powder (EWP). Additionally, the egg white based composition may include a number of other additives.

To provide context, the inventor has been involved in research of egg white based compositions for a number of years, and has developed a novel composition which retains excellent foam stability and foamability characteristics, and offers many advantages over conventional egg white foaming methods and compositions. Yet, a problem which was identified during this R&D process was that the gas sparging method is not particularly practical for “on the go” applications, particularly due to the manufacturing costs associated with the pressurized canister requirements for gas sparging. The present invention avoids the need to gas sparging methods, which in some circumstances may be impractical or cost-prohibitive for certain types of food products.

The inventor also notes that once the material has been foamed, the apparatus 1 may also be conveniently used to subsequently heat or cook the foamed material. Particularly with egg white compositions that have been foamed, the ability to subsequently cook the foamed egg white in the apparatus opens up additional commercial opportunities for “on-the-go” or at home food products. For instance, after the egg white material has been foamed in the apparatus 1, the user may cut off at top section of the apparatus 1, then inserted into a microwave to cook the material.

It should be appreciated that other materials besides egg white may be foamed using the same inventive concept described in the present invention.

Method of Use

The present invention provides for a method of foaming a material in the foaming apparatus 1 by applying a force to an external portion on an enclosure 2 to cause material transfer under pressure through a zone of constriction 6, and foaming the material.

Preferably, the method includes incorporating an amount of gas into the first cavity 8 prior to starting the foaming method.

This may be useful to avoid long-term storage of the gas in the apparatus 1, which may otherwise cause deterioration of the food product. This is especially true for egg whites, where atmospheric air may cause loss of shelf life.

Preferably, the method includes applying the force for 15 to 20 seconds.

Preferably, the method includes applying a back and forth force on an external portion of the first cavity 8 and second cavity 9 sufficient to cause transfer of the material back and forth between the first cavity 8 and second cavity 9 through the zone of constriction 6.

Preferably, after the applying step, the user accesses the foamed material for consumption.

The access of the foamed material may be achieved in a number of ways, depending on the embodiment of the invention.

For instance, in the embodiment referred to in Example 1, the user may force the foam to reside in the first cavity 8, then open up the external outlet 3 to allow the foamed material to be forced out. For example the user may roll the apparatus 1 to force the material through the external outlet 3, and not back through the zone of constriction 6.

In an embodiment shown by Example 2, the clamp 10 may be removed, and converted to a handle. The user may then choose to dispense the material through the external outlet 3, or could alternatively cut off a top portion of the apparatus to provide greater access to the foamed material. In the latter option, the user may dispense the foamed material with a spoon, which the inventor envisages ideally would be provided together with the apparatus 1 at sale, or somehow connected to the apparatus 1.

Summary of Advantages

The present invention provides convenient foaming of egg whites quickly and easily without the need for conventional techniques such as whipping, gas sparging and shaking, which are particularly impractical for settings outside of the kitchen, provides a solution to the problem to allow athletes, and other users to quickly and easily make a foamed egg white “on the go”, avoids the need to drink raw liquid egg whites which has a displeasing mouth feel, look and association with raw eggs, and instead which provides a foamed product with pleasing sensory perception characteristics, avoids the need to mask the liquid egg whites by mixing/blending in a blender which is often what athletes currently do (which is also inconvenient), avoids problems with manufacturing/costs associated with gas sparging methods or alternative foaming methods, provides a solution to the problem that easily allows flavorings/additives to be added to the raw egg white liquid, such that the resulting egg white foams can be made into a variety of products, and/or provides an opportunity to subsequently cook the foamed material in the apparatus suitable for use on a wide number of non-food based materials.

The invention is further described in detail by reference to the following experimental examples. These examples are provided for the purpose of illustration only, and are not intended to be limiting unless otherwise specified. Thus, the invention should in no way be construed as being limited to the following examples, but rather, should be construed to encompass any and all variations which become evident as a result of the teaching provided herein.

### EXAMPLE 1

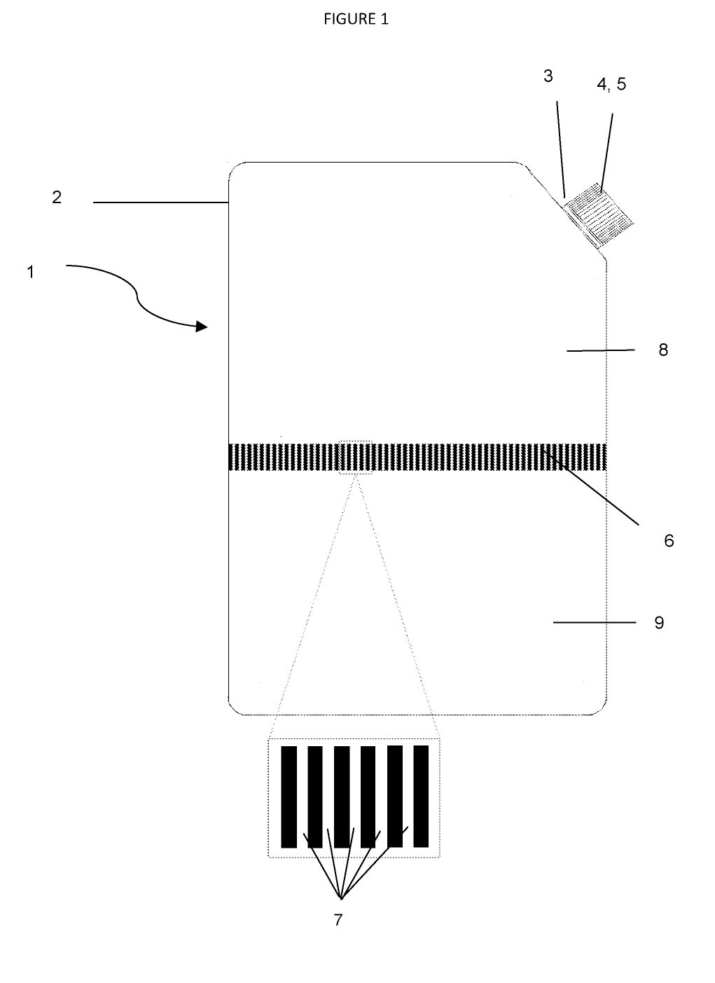

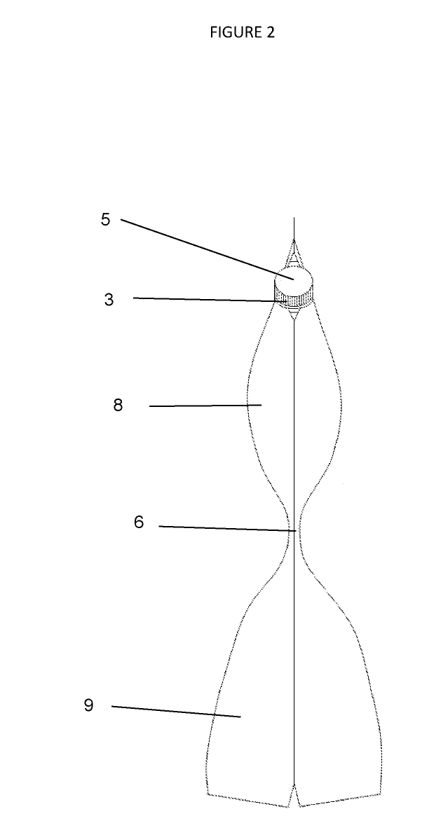

As shown in FIGS. 1 and 2 the apparatus 1 is a pliable plastic container with an enclosure 2. The enclosure 2 includes an external outlet 3 with a cap 4 with a removable lid 5.

The mid-section of the apparatus 1 includes a zone of constriction 6 configured as multiple channels 7 that form between portions of the opposing internal walls that are connected along a mid-portion of the apparatus 1 to separate a first cavity 8 from the second cavity 9.

An egg white composition is stored in the second cavity 9. Prior to foaming, a gas is put in the first cavity 8 via the external outlet 3. To foam the egg white composition, the user pumps the apparatus 1 in a back and forth manner by applying, in turn, a pressure to external portions on the first cavity 8 and second cavity 9 sufficient to drive the material back and forth between the first cavity 8 and second cavity 9 through the zone of constriction 6. The high shear and high pressure caused by the zone of constriction 6 helps to form the foam. Whilst the gas significantly aids the foam formation, it is not critical.

### EXAMPLE 2

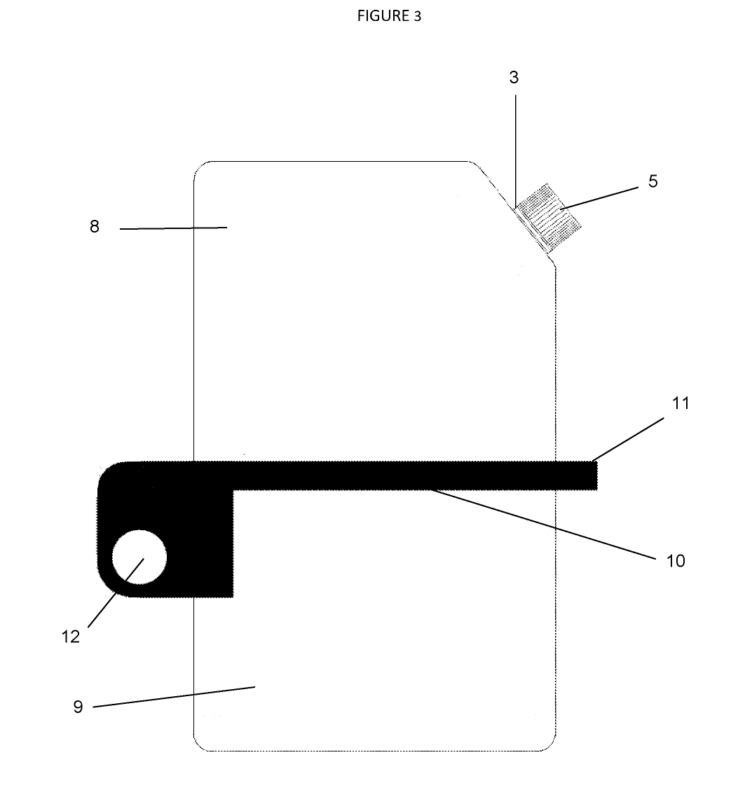

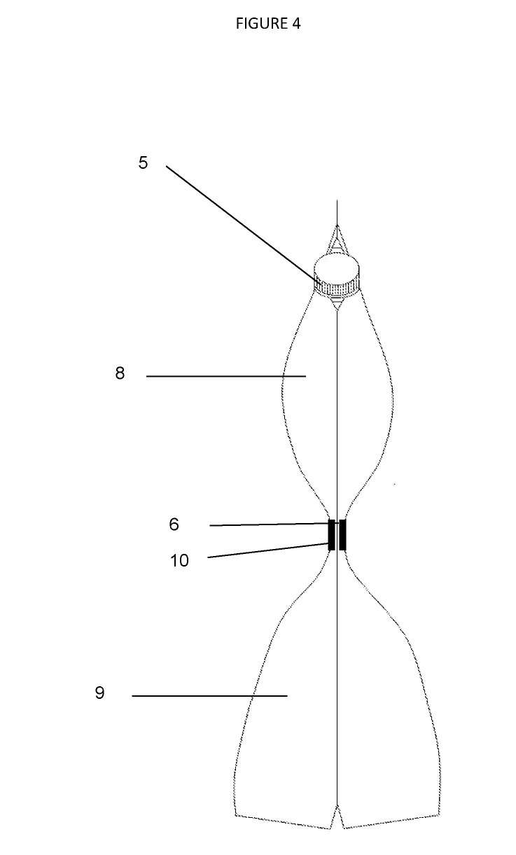

As shown in FIGS. 3 and 4 the zone of constriction is formed by a clamp 10, defining a first cavity 8 above it, and a second cavity 9 below it. The clamp 10 is also configured to have a securing portion 11 and a finger portion 12 portion, so that after the foaming action is completed, the clamp 10 is disengaged via a securing portion 11 reverses upon itself to form a handle (not shown), which the user can grip and insert a finger via finger portion 12.

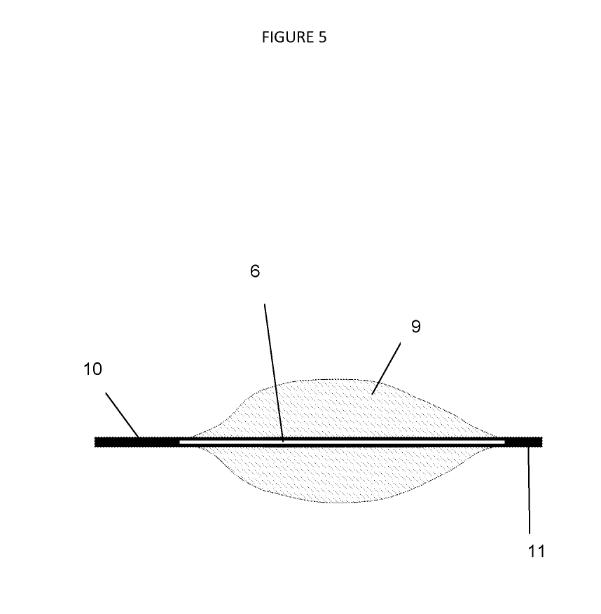

FIG. 5 shows a cross-sectional view of the same embodiment showing the clamp 10, and the zone of constriction 6 located in between two portions of the clamp 10. The apparatus 1 is shown below, with the enclosure 2 bulging out below the clamp 10 to form the second cavity 9.

### EXAMPLE 3

Although not shown in any Figures, another example is to foam the material in the apparatus by using a vending machine scenario that is configured to clamp the apparatus along a midsection of the apparatus to form the zone of constriction, and the first and second cavities, temporarily. Once a mechanical force is applied to force the material back and forth through the zone of constriction into each cavity sufficient to foam the material, the clamp is then released, and the apparatus is dispensed for consumption.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavor in any country in the world.

The invention may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

Aspects of the present invention have been described by way of example only and it should be appreciated that modifications and additions may be made thereto without departing from the scope thereof.

1.-16. (canceled)

17. A foaming apparatus comprising an enclosure including a first and second cavity located therein, wherein said enclosure includes at least one zone of constriction defined by internal surface(s) of said enclosure located between said first cavity and said second cavity in said enclosure, wherein said at least one zone of constriction allows the only transfer of a material to be foamed between said first cavity and said second cavity, and wherein said zone of constriction is configured to foam said material as said material is transferred through said zone of constriction in a back and forth fashion between said first cavity and said second cavity.

18. The foaming apparatus of claim 17, wherein walls of said enclosure are made substantially of a pliable material.

19. The foaming apparatus of claim 17, wherein said first cavity and said second cavity have approximately the same internal volume.

20. The foaming apparatus of claim 17, wherein said first cavity is configured to include an external outlet.

21. The foaming apparatus of claim 17, wherein said zone of constriction is configured as at least one channel that forms between opposing portions of internal walls that are connected along a mid-portion of said enclosure to separate said first cavity from said second cavity.

22. The foaming apparatus of claim 21, wherein said zone of constriction includes multiple channels.

23. The foaming apparatus of claim 17, wherein said zone of constriction is configured by a clamp that is applied outside of said apparatus that effectively draws opposing internal walls of said apparatus almost together along a mid-part of said enclosure, thus forming said first cavity and said second cavity on opposing sides of said clamp.

24. The foaming apparatus of claim 17, wherein said material is chosen from the group consisting of an egg white liquid and egg white based composition.

25. A method of foaming a material in a foaming apparatus, including the steps of:
applying a force to an external portion on an enclosure to cause material transfer under pressure through a zone of constriction; and
foaming the material.

26. The method of claim 25, further including prior said applying step, the step of incorporating an amount of gas into a first cavity.

27. The method of claim 25, wherein said applying step is further defined as applying the force for 15 to 20 seconds.

28. The method of claim 25, wherein said applying step further includes the step of applying a back-and-forth force on an external portion of the first and second cavities sufficient to cause transfer of the material back and forth between the first and second cavities through the zone of constriction.

29. The method of claim 25, further including the step of a user accessing the foamed material for consumption.

30. The method of claim 29, wherein said user accessing step is further defined as the user forcing the foam to reside in the first cavity, then opening up the external outlet and allowing the foamed material to be forced out.
